(19) United States
(12) Patent Application Publication
(10) Pub. No.: US 2006/0004832 A1
(43) Pub. Date: Jan. 5, 2006

(54) Enterprise infrastructure management appliance

(76) Inventors: Richard G. Langsford, Tierra Verde, FL (US); Alexander S. Ryals, Pelham, AL (US)

Correspondence Address: Law Office of John F. Kacvinsky, LLC, Suite 300, 4500 Brooktree Road, Wexford, PA, 15090, US

(21) Appl. No.: 10/865,303

(22) Filed: Jun. 10, 2004

(51) Int. Cl. G06F 17/00

(52) U.S. Cl. 707/102

(57) ABSTRACT

Method and apparatus for an enterprise infrastructure management appliance are described.

### REFERENCE TO COMPUTER PROGRAM LISTING APPENDIX

The Application includes a Computer Program Listing Appendix (CPLA) submitted on compact discs labeled “1003.0003 CPLA COPY 1” and “1003.0003 CPLA COPY 2”, with both 1003.0003 CPLA COPY 1 and 1003.0003 CPLA COPY 2 having identical material, the material to comprise the following twenty-eight (28) files: AdminUtilities.java/20KB, AdvQuery.java/5KB, ChartUtilities.java/8KB, CmdLine.java/5KB, GenerateExcelServlet.java/7KB, Genxls.java/10KB, GetCommandStatus.java/3KB, GridDataServlet.java/25KB, Licensejava./1KB, MaintUtilities.java/2KB, MenuServlet.java/14KB, NodesServlet.java/6KB, NodeUtilities.java/4KB, OvStatus.java/4KB, ParseHTML.java/2KB, PieConfigServlet.java/4KB, PieDataServlet.java/4KB, PortalFilter.java/19KB, PropertyData.java/88KB, ReportUtilities.java/3KB, RunCmd.java/6KB, ServiceUtilities.java/5KB, SglWrapper.java/6KB, StrutsValidator.java/10KB, TemplateServlet.java/7KB, TemplateUtilities.java/34KB, TreeServlet.java/22KB, and XmlUtilities.java/22KB, all of which have a creation date of Jun. 10, 2004, and all of which are hereby incorporated by reference in their entirety to the Application.

### BACKGROUND

Enterprise management techniques attempt to provide centralized management of a heterogeneous Information Technology (IT) environment. For example, enterprise management techniques attempt to align users, business operations, and technologies to share expectations and measure performance against established service level agreements. A typical enterprise management solution provides technology for fault, performance and service management, as well as network configuration, activation, mediation, and other network management operations. The complexity of enterprise management applications, however, may make implementing such applications difficult in some IT environments. Consequently, there may be a need for improved enterprise management techniques in a device or network.

### BRIEF DESCRIPTION OF THE DRAWINGS

The subject matter regarded as the embodiments is particularly pointed out and distinctly claimed in the concluding portion of the specification. The embodiments, however, both as to organization and method of operation, together with objects, features, and advantages thereof, may best be understood by reference to the following detailed description when read with the accompanying drawings in which:

FIG. 1 illustrates a system 100 in accordance with one embodiment;

FIG. 2 illustrates a system 200 in accordance with one embodiment;

FIG. 3 illustrates a system 300 in accordance with one embodiment;

FIG. 4 illustrates a programming logic 400 in accordance with one embodiment; and

FIG. 5 illustrates a report 500 in accordance with one embodiment.

### DETAILED DESCRIPTION

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

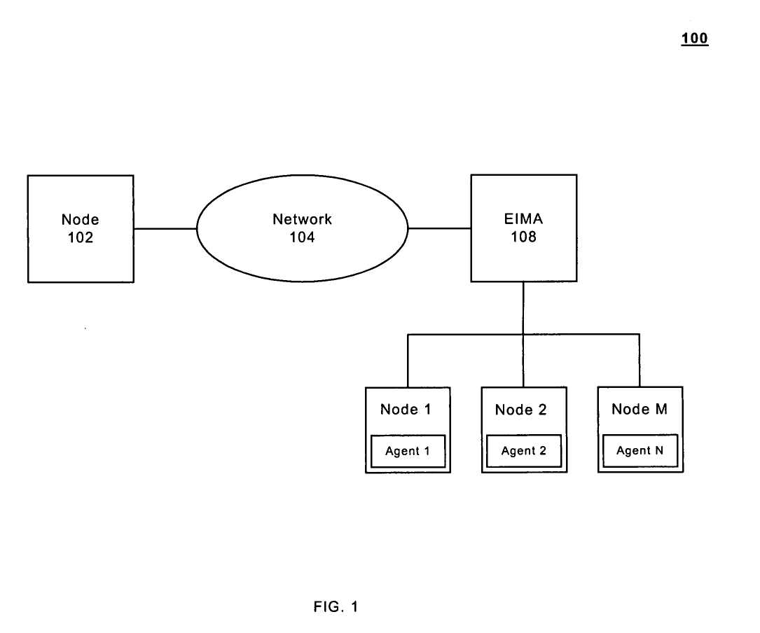

Referring now in detail to the drawings wherein like parts may be designated by like reference numerals throughout, there is illustrated in FIG. 1 a block diagram of a system 100 in accordance with one embodiment. System 100 may comprise, for example, a communication system to communicate information between multiple nodes. A node may represent any physical or logical entity having a unique address in system 100. The unique address may comprise, for example, a network address such as an Internet Protocol (IP) address, device address such as a Media Access Control (MAC) address, and so forth. A node may refer to an element, module, component, board or device that may process a signal representing information. The signal may be, for example, an electrical signal, optical signal, acoustical signal, chemical signal, and so forth. The embodiments are not limited in this context.

The nodes may be connected by one or more types of communications media. The communications media may comprise any media capable of carrying information signals, such as metal leads, semiconductor material, twisted-pair wire, co-axial cable, fiber optics, radio frequency (RF) spectrum, and so forth. The connection may comprise, for example, a physical connection or logical connection. The embodiments are not limited in this context.

The general architecture of system 100 may be implemented as a wired or wireless system. If implemented as a wireless system, one or more nodes shown in system 100 may further comprise additional components and interfaces suitable for communicating information signals over the designated RF spectrum. For example, a node of system 100 may include omni-directional antennas, wireless RF transceivers, control logic, and so forth. The embodiments are not limited in this context.

In one embodiment, the nodes of system 100 may communicate information to each other in the form of packets or frames. A packet or frame in this context may refer to a discrete set of information of a limited length, with the length typically represented in terms of bits or bytes. An example of a packet length might be 1000 bytes.

In one embodiment, the nodes of system 100 may be configured to communicate different types of information, such as media information and control information. Media information may refer to any data representing content meant for a user, such as voice information, video information, audio information, text information, alphanumeric symbols, graphics, images, and so forth. Control information may refer to any data representing commands, instructions or control words meant for an automated system. For example, control information may be used to route media information through a system, or instruct a node to process the media information in a predetermined manner.

The nodes may communicate the media and control information in accordance with one or more protocols. A protocol may comprise a set of predefined rules or instructions to control how the nodes communicate information between each other. The protocol may be defined by one or more protocol standards, such as the standards promulgated by the Internet Engineering Task Force (IETF), International Telecommunications Union (ITU), and so forth. In one embodiment, for example, the protocol may include one or more Internet protocols, such as defined by the IETF document titled “Transmission Control Protocol,” Standard 7, Request For Comment (RFC) 793, September, 1981, and the IETF document titled “Internet Protocol,” Standard 5, RFC 791, September, 1981 (collectively referred to as the “TCP/IP Specification”). The embodiments are not limited in this context.

Referring again to FIG. 1, system 100 may comprise node 102, a network 104, an enterprise infrastructure management appliance (EIMA) 108, and nodes 1-M. Although FIG. 1 shows a limited number of elements, it can be appreciated that any number of elements may be used in system 100 in any number of different topologies. Further, although the embodiments may be illustrated in the context of a wired communications system, the principles discussed herein may also be implemented in a wireless communications system as well. The embodiments are not limited in this context.

In one embodiment, system 100 may comprise node 102. Node 102 may comprise a remote access node. Examples of a remote access node may include a processing system, such as computer, personal computer (PC), laptop computer, ultra-portable computer, personal digital assistant (PDA), workstation, server, cellular telephone, handheld data communication device, and so forth. Remote access node 102 may include a web browser module. Examples of a web browser module may include a web browser such as Microsoft® Internet Explorer made by Microsoft Corporation, Netscape Navigator made by Netscape Corporation, and so forth. A user may attempt to access information on another node such as EIMA 108 using the web browser module. The information may comprise, for example, a web page such as a Hypertext Markup Language (HTML) document or Extensible HTML (XML) document. The user may initiate the action by typing in an information identifier for the web page. An example of an information identifier may be a uniform resource locator (URL). The browser may then use the URL to attempt to establish a connection between remote access node 102 and EIMA 108 via network 104. Once the connection has been established, the web browser module may then communicate information between remote access node 102 and EIMA 108 using the connection. These operations may be performed in accordance with a number of different protocols, such as the Hypertext Transfer Protocol (HTTP) Version 1.1 as defined by the Internet Engineering Task Force (IETF) Draft Standard Request For Comment (RFC) 2616, June 1999 (“HTTP Specification”), and the Secure HTTP (SHTTP) as defined by the IETF standard RFC 2660, August 1999 (“SHTTP Specification”), the Transport Layer Security (TLS) as defined by the IETF standard RFC 2246 (“TLS Specification”), January 1999, one or more Secure Socket Layer (SSL) protocols, and so forth. The embodiments are not limited in this context.

In one embodiment, system 100 may comprise network 104. Network 104 may comprise any number of network nodes connected by any type of communications media in any number of different topologies. Network 104 may be arranged to communicate information between the various nodes of system 100. For example, network 104 may comprise a packet data network such as a Local Area Network (LAN) or Wide Area Network (WAN), a Public Switched Telephone Network (PSTN), a wireless network such as cellular telephone network or satellite network, or any combination thereof. Network 104 may communicate information in accordance with any number of different data communication protocols, such as one or more Ethernet protocols, one or more Internet protocols such as defined by the TCP/IP Specification, one or more WWW protocols such as defined by the HTTP Specification or SHTTP Specification, the Wireless Access Protocol (WAP), and so forth. The embodiments are not limited in this context.

In one embodiment, system 100 may include nodes 1-M. Nodes 1-M may represent nodes for a client domain. Examples of a node may include a processing system, such as computer, PC, laptop computer, ultra-portable computer, PDA, workstation, server, and so forth. A client domain may encompass the technical resources for a single entity, such as a company or organization. A client domain may also be sometimes referred to as an “enterprise” in the IT industry. A large company typically has a large number of technical resources dispersed across various geographic locations and business divisions. For example, a company may have multiple offices in different geographic locations, with each location having its own local area network (LAN) or metropolitan area network (MAN). The various networks from each location may in turn be connected to form a wide area network (WAN). This may lead to a relatively complex network. In addition, the nodes may have different hardware platforms using different operating systems (OS) and executing different application programs. For example, one node may comprise a computer using a Pentium® processor made by Intel® Corporation and a Windows® OS made by Microsoft Corporation. In another example, one node may comprise a computer using a SPARC® processor made by Sun® Microsystems and a Solaris® OS made by Sun Microsystems or Linux OS made by Red Hat Enterprise Linux. In yet another example, one node may comprise a computer using a POWER4+® processor made by IBM® Corporation, and an AIX 5L® OS made by IBM Corporation. Further, a client domain may have many business divisions, with each division having different business objectives supported by varied technical resources and application programs. Consequently, any given client domain may comprise a large and complex heterogeneous IT environment, comprising various networks, internetworking devices, processing platforms, computers, servers, and so forth. Accordingly, a number of enterprise management techniques have been developed in an attempt to manage such heterogeneous IT environments.

Conventional enterprise management techniques, however, may be unsatisfactory for a number of reasons. For example, conventional enterprise management techniques may attempt to install client agents on each node for a client domain. Since each node may comprise different hardware and software, it may be necessary to manually configure each node on an individual basis. In another example, conventional enterprise management techniques may require a large number of dedicated personnel to install, monitor and repair various types of enterprise management solutions. In yet another example, conventional enterprise management techniques may have a level of complexity requiring specialized expertise, which can only be gained through expensive training of company personnel or outside consultants. In yet another example, conventional enterprise management techniques may have a complex user interface to access the features and capabilities for an enterprise management application.

In one embodiment, EIMA 108 may be designed to solve these and other problems. EIMA 108 may be arranged to perform enterprise management operations for a client domain, such as a client domain having nodes 1-M. EIMA 108 may consolidate enterprise management operations and reduce the complexity of managing the technical resources for a given client domain to a single device. As a result, users may realize increased performance and services while reducing the total costs associated with enterprise management solutions.

In one embodiment, EIMA 108 may be implemented in the form of a network appliance. A network appliance may comprise a dedicated device, such as a computer or server, that is preconfigured with various application programs. A network appliance may provide several advantages. For example, many manual operations needed to implement enterprise management operations may be automated. The term “automated” or “automatic” as used herein may refer to performing operations without human intervention. A network appliance may be arranged for “plug-and-play” operation, where a user may attach the network appliance to an existing network for a given client domain, and the network appliance will automatically perform a number of different enterprise management operations, such as discovery of nodes for a client domain, provisioning nodes with client agents, configuring the client agents, monitoring activity messages from the client agents, mediating conflicts between nodes, and so forth. In another example, a network appliance may also provide a centralized command and control for enterprise management operations by reducing all needed hardware and software to a single device. In yet another example, a network appliance may facilitate remote access or web access to administer or perform enterprise management operations. A user may use remote access node 102 to access the network appliance over network 104, such as the Internet, for example. This may allow remote management, remote troubleshooting, remote monitoring, remote maintenance, and so forth. Although one embodiment may be implemented using a network appliance, it may be appreciated that EIMA 108 may be implemented using other techniques, such as software installed on a computer or server. The embodiments are not limited in this context.

In general operation, system 100 may operate to perform enterprise management for nodes 1-M. EIMA 108 may be arranged to perform various enterprise management operations, such as platform implementation, automation enhancement, implement enterprise service management operations, provide enterprise support services, and so forth. Platform implementation, for example, may involve installing toolsets and client agents 1-M to implement a standard set of monitors for system, application and network monitoring operations. The monitoring operations may include base level network and systems performance monitoring, service and application monitoring, notification and alarm operations, mediation and escalation operations, and so forth. Automation enhancement, for example, may give a user proactive management control over critical networks and systems, thereby providing improved techniques to detect problems and automate corrective actions. Enterprise service management, for example, may include a set of policies and procedures to implement operational techniques, procedures, and roles at different tiers of the client domain, from individual engineering and analyst staff to the Network Operations Center (NOC) level. Enterprise support services, for example, may include techniques for application and system management, network management, web services and application management, storage and data management, Internet service usage, and so forth. It may be appreciated that these are merely examples of possible enterprise management operations, and the embodiments are not limited in this context.

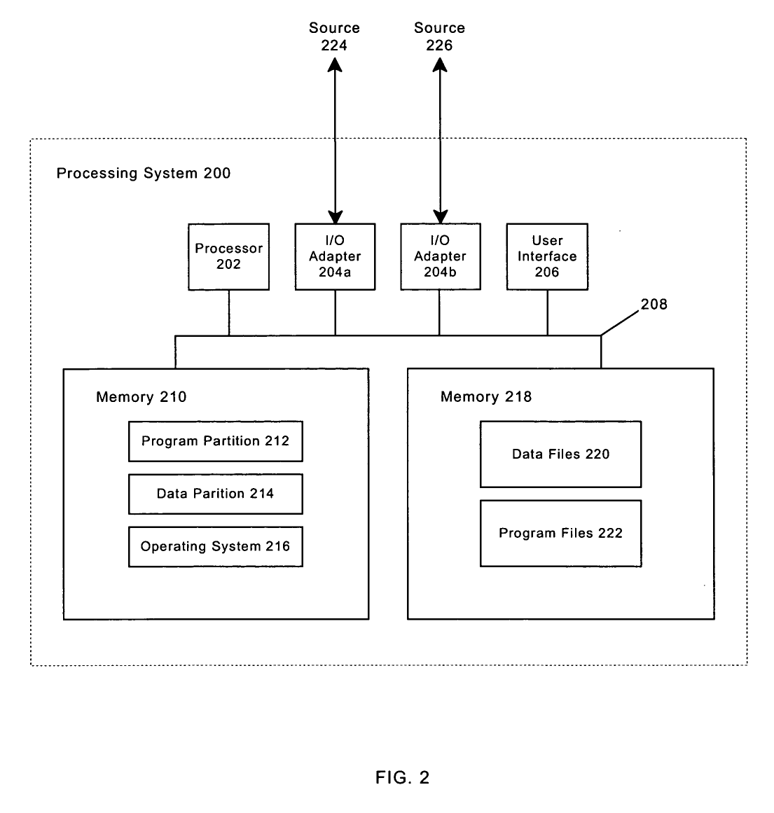

FIG. 2 illustrates a block diagram of a system 200. System 200 may represent a network appliance having a processing system to implement one or more elements of system 100, such as EIMA 108 described with reference to FIG. 1, for example. As shown in FIG. 2, EIMA 200 may include one or more processors 202, multiple I/O adapters 204a-b, a receiver 206, a memory 210 and disk storage 218. These elements may be connected by bus 208, which allows data to be intercommunicated between the elements. Although EIMA 200 is shown with a limited number of elements for purposes of clarity, it may be appreciated that other elements may be added to EIMA 200. For example, EIMA 200 may have a display unit, keyboard, mouse, printer, external drives, and so forth, with the appropriate I/O adapters for each. The embodiments are not limited in this context.

In one embodiment, EIMA 200 may include I/O adapters 204a and 204b. I/O adapters 204a and 204b may each comprise a network adapter or network interface card (NIC) configured to operate with any suitable technique for controlling communication signals between computer or network devices using a desired set of communications protocols, services and operating procedures, for example. In one embodiment, I/O adapters 204a-b may operate, for example, in accordance with the TCP/IP Specification, although the embodiments are not limited in this context. I/O adapters 204a-b also include appropriate connectors for connecting I/O adapters 204a-b with suitable communications media. I/O adapters 204a-b may receive communication signals from any number of sources, such as sources 224 and 226, respectively. Sources 224 and 226 may include any devices internal or external to EIMA 200, such as remote access node 102 and/or another component of EIMA 200. The communication signals may be received by I/O adapters 204a-b over any suitable media, including metal leads, semiconductor material, twisted-pair wire, co-axial cable, fiber optic, RF, and so forth. The embodiments are not limited in this context.

In one embodiment, EIMA 200 may comprise processor 202. Processor 202 can be any type of processor capable of providing the speed and functionality desired for an embodiment. For example, processor 202 could be a processor made by Intel® Corporation and others. Processor 202 may also comprise a digital signal processor (DSP) and accompanying architecture, such as a DSP from Texas Instruments Incorporated. Processor 202 may further comprise a dedicated processor such as a network processor, embedded processor, micro-controller, controller and so forth.

In one embodiment, memory 210 and 218 may comprise any machine-readable media capable of storing program instructions and data adapted to be executed by a processor. Some examples of machine-readable media include, but are not limited to, read-only memory (ROM), random-access memory (RAM), dynamic RAM (DRAM), double DRAM (DDRAM), static RAM (SRAM), programmable ROM, erasable programmable ROM, electronically erasable programmable ROM, flash memory, magnetic disk (e.g., floppy disk and hard drive), optical disk (e.g., CD-ROM) and any other media that may store digital information. Further, EIMA 200 may contain various combinations of machine-readable storage devices through various 1/O controllers, which are accessible by processor 202 and which are capable of storing a combination of computer program instructions and data.

In one embodiment, the term “program instructions” may include computer code segments comprising words, values and symbols from a predefined computer language that, when placed in combination according to a predefined manner or syntax, cause a processor to perform a certain function. Examples of a computer language may include C, C++, JAVA, assembly and so forth. The instructions may be stored on the media in a compressed and/or encrypted format. As used herein, the phrase “adapted to be executed by a processor” is meant to encompass instructions stored in a compressed and/or encrypted format, as well as instructions that have to be compiled or installed by an installer before being executed by processor 202.

In one embodiment, memory 210 is accessible by processor 202 over bus 208 and includes a program partition 212, a data partition 214, and an operating system 216. An example of operating system 216 may comprise an operating system sold by Microsoft Corporation, such as Microsoft Windows® 95, 98, 2000, NT and XP, for example. Program partition 212 stores and allows execution by processor 202 of program instructions that implement the functions of each respective system described herein. Data partition 214 is accessible by processor 202 and stores data used during the execution of program instructions.

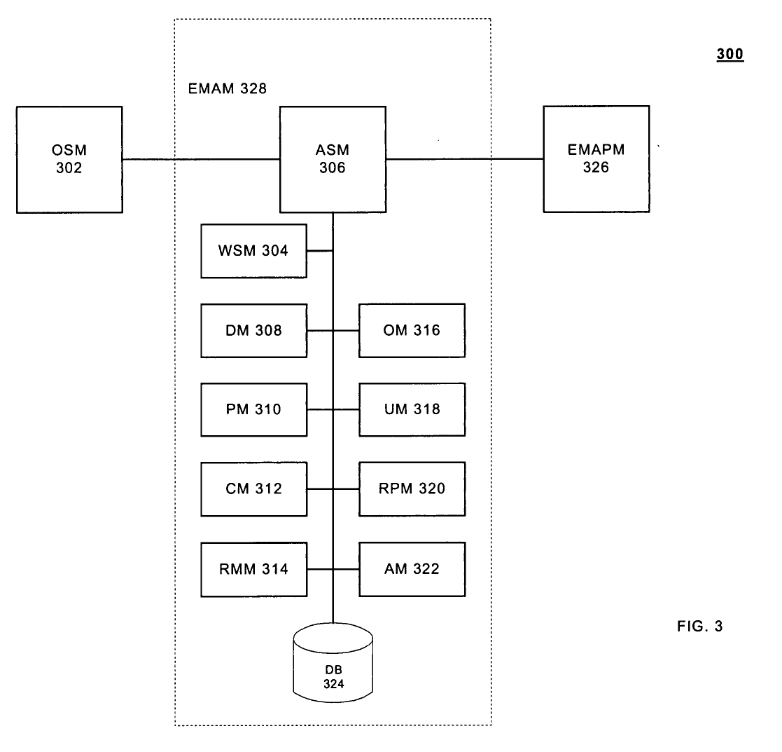

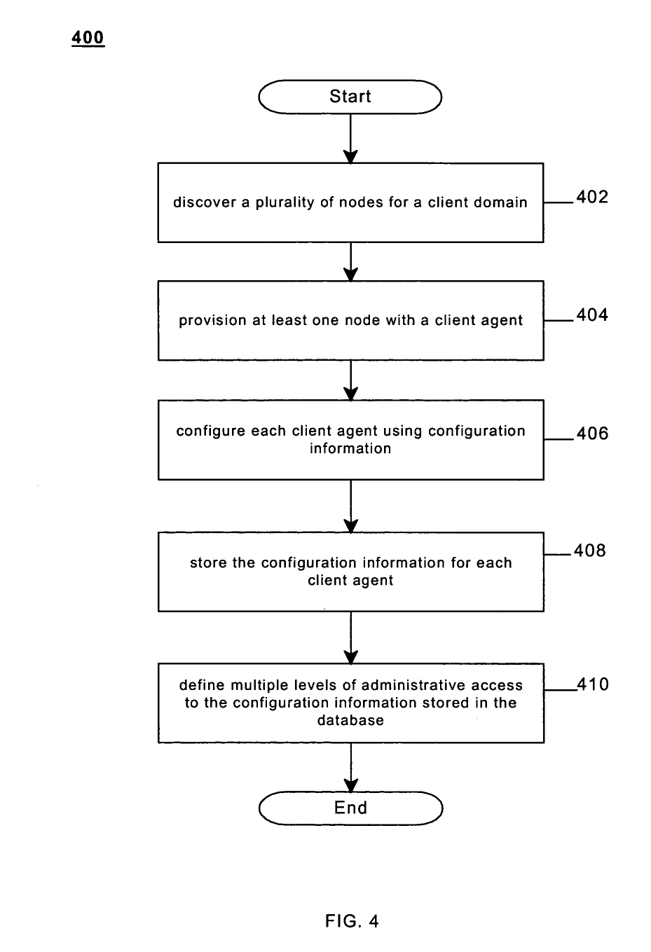

In one embodiment, program partition 212 may contain various program instructions that may be grouped into one or more modules to perform various sets of operations. Although the embodiment has been described in terms of “modules” to facilitate description, one or more circuits, components, registers, processors, software subroutines, or any combination thereof could be substituted for one, several, or all of the modules. The modules for EIMA 200 may be described in more detail with reference to FIGS. 3-4.

FIG. 3 may illustrate a system 300. System 300 may be representative of multiple modules for use with, for example, EIMA 200. As shown in FIG. 3, EIMA 300 may include an OS module (OSM) 302, an Enterprise Management Access Module (EMAM) 328, and an Enterprise Management Application Module (EMAPM) 326. Although FIG. 3 shows a limited number of modules, it can be appreciated that any number of modules may be used in EIMA 300.

In one embodiment, EIMA 300 may include OSM 302. OSM 302 may include any conventional OS appropriate for a network appliance. More particularly, the selected OS should provide security and transparent configurations for appliance operations. Examples for OSM 302 may include a Windows OS, Solaris OS, Linux OS, AIX OS, and so forth. The embodiments are not limited in this context.

In one embodiment, EIMA 300 may include EMAPM 326. EMAPM 326 may be arranged to perform enterprise management operations for a plurality of nodes, such as nodes 1-M. Examples of EMAPM 326 may include the HP Openview® Management Integration Platform made by Hewlett-Packard® Company, the Unicenter Management Portal made by Computer Associates®, Patrol® made by BMC Software, Inc., Tivoli Management Framework® made by IBM Corporation, and so forth. In one embodiment, for example, EMAPM 326 may comprise HP Openview. Although HP Openview is used by way of example, it may be appreciated that any enterprise management application module may be used and still fall within the scope of the embodiments. The embodiments are not limited in this context.

In one embodiment, EIMA 300 may include EMAM 328. EMAM 328 may be arranged to perform administrative operations for EMAPM 326. EMAM 328 may comprise, for example, a role based web management portal to assist in managing and administering EMAPM 326. More particularly, EMAM 328 may be arranged to provide administrative operational capabilities to assist a user in accessing and administering the enterprise management operational capabilities provided by EMAPM 326. EMAM 328 may be tightly integrated with EMAPM 326, and may interface with EMAPM 326 via a preconfigured set of Application Program Interfaces (API) and utilities. A user may use EMAM 328 to access the various enterprise management operations provided by EMAPM 326, as well as the configuration information for such operations, without necessarily having to use the user interface provided by EMAPM 326, if any. An example of EMAM 328 may include Advanced Access™ made by Pepperweed® Consulting, LLC. The embodiments are not limited in this context.

In one embodiment, EMAM 328 may comprise various modules, such as ASM 306, WSM 304, discovery module (DM) 308, provisioning module (PM) 310, configuration module (CM) 312, role management module (RMM) 314, outage module (OM) 316, utility module (UM) 318, reporting module (RPM) 320, and database access module (AM) 322. Each of these modules may be implemented using, for example, programming logic described in one or more CPLA files as stored on compact discs 1003.0003 CPLA COPY 1 and 1003.0003 CPLA COPY 2, which have been incorporated by reference, in accordance with pseudo-code as provided herein, or with any other suitable programming logic in any programming language. The embodiments are not limited in this context.

In one embodiment, EMAM 328 may include ASM 306. ASM 306 may provide a scalable web application server engine and framework for EIMA 300. ASM 306 may comprise a component-based product that resides in the middle-tier of a server centric architecture. It provides middleware services for security and state maintenance, along with data access and persistence. In one embodiment, for example, ASM 306 may comprise a Java application server. Java application servers may be based on the Java™ 2 Platform, Enterprise Edition (“J2EE™”), Java Server Pages (JSP), Java Servlet Container (JSC), Model View Controller framework (MVC), and so forth. For example, J2EE uses a multi-tier distributed model. This model generally includes a Client Tier, a Middle Tier, and an Enterprise Information System (EIS) Tier. The Client Tier can include one or more applications or browsers. The J2EE Platform is in the Middle Tier and may consist of web server module (WSM) 304 and an Enterprise JavaBeans™ (EJB) server, both of which may sometimes be referred to as “containers.” There can be additional sub-tiers in the middle tier. The EIS tier has the existing applications, files, and databases. The database may be, for example, database 324. For the storage of business data, the J2EE platform may require a database that is accessible through the Java Database Connectivity (JDBC), Structured Query Language Java (SQLJ), or Java Data Objects (JDO) API. The database may be accessible from web components, enterprise beans, and application client components. The database does not necessarily need to be accessible from applets. Examples of ASM 306 may include BEA® WebLogic® Server made by BEA Systems, Inc., IBM WebSphere Server made by IBM Corporation, Oracle® 10G made by Oracle Corporation, and so forth. The embodiments are not limited in this context.

In one embodiment, EMAM 328 may include WSM 304. WSM 304 may be embedded with ASM 306 as previously described, or may comprise a separate module as shown in FIG. 3. WSM 304 may provide web access to one or more modules of EIMA 300. WSM 304 may operate in cooperation with remote access node 102 to provide an appliance administrator or role based administers with remote access to the capabilities of EIMA 300. For example, a user may establish a connection between remote access node 102 and WSM 304. The connection may be any type of secure or unsecure connection, such as a connection in accordance with the HTTP Specification, SHTTP Specification, and so forth. The type of connection may vary in accordance with a number of factors, such as bandwidth requirements, latency requirements, security requirements, and so forth. Once a connection has been established between remote access node 102 and WSM 304, a properly authenticated user may remotely access the capabilities offered by EIMA 300.

In one embodiment, EMAM 328 may include AM-322 and database 324. AM 322 and database 324 may comprise a database management system for EIMA 300. Database 324 may be used for persistent data store of information for EIMA 300, including configuration information for EIMA 300 and client agents 1-N, defined relationships to EMAPM 326, and so forth. AM 322 may be a database controller to handle internal/external commands and API requests for one or more databases, such as database 324, any external databases, and so forth. Any number of database management systems may be used for AM 322 and database 324. In one embodiment, for example, AM 322 and database 324 may be implemented as an embedded Java database system, such as Daffodil™ Database made by Daffodil Software Ltd., PointBase® made by DataMirror Mobile Solutions, Inc., and so forth. The embodiments are not limited in this context.

In one embodiment, AM 322 may be implemented in accordance with the programming logic described in one or more CPLA files as stored on compact discs 1003.0003 CPLA COPY 1 and 1003.0003 CPLA COPY 2, such as “SqlWrapperjava”, for example. The embodiments are not limited in this context.

In one embodiment, EMAM 328 may include DM 308. DM 308 may perform automated discovery of existing and candidate nodes for a client domain. DM 308 may traverse the networks of a client domain and compile a list of candidate nodes appropriate for installing one or more client agents, such as nodes 1-M. The list of candidate nodes may be send to provisioning module (PM) 310.

In one embodiment, for example, DM 308 may be implemented in accordance with the programming logic described in the following pseudo-code:

jdbc connect to CMDB datasource {

get CMDB DB user/pass from embedded EIMA database
connect CMDB DB
map nodeinfo {

get nodename, IP, OS type

}

jdbc connect to LDAP datasource {

get LDAP user/pass from embedded EIMA database
connect LDAP/ActiveDirectory
map nodeinfo {

get nodename, IP, OS type

}

jdbc connect to external EMAPM datasource {

get EMAPM DB user/pass from embedded EIMA database
connect EMAPM DB
map nodeinfo {

get nodename, IP, OS type

}

file connect to seed datasource {

get seed file source from embedded EIMA database
read seed file
map nodeinfo {

get nodename, IP, OS type

}

import_nodeinfo (nodeinfo) {

add nodeinfo to EIMA embedded DB
add nodeinfo to EIMA EMAPM DB
}

discover {

call connect to CMDB datasource
call connect to LDAP datasource
call connect to EMAPM datasource
call connect to seed datasource
} //called on scheduled or manual basis

In one embodiment, EMAM 328 may include PM 310. PM 310 may receive the list of candidate nodes from PM 310. PM 320 may determine the hardware and software platform for each candidate node, and install one or more client agents I-N suitable for use with each type of candidate node. PM 320 may also uninstall client agents, such as in preparation for removal, replacement or maintenance of a monitored node. The install/uninstall operations may be automated or manual, depending upon the individual characteristics of each node 1-M. In one embodiment, for example, PM 3 10 may generate two lists, with the first list to identify those nodes 1-M that are eligible for automatic installation, and the second list to identify those nodes 1-M that are not eligible for automatic installation. PM 310 may then perform the install/uninstall operations for the first list in response to control information provided by a user, or in accordance with a set of predefined rules. A user may use PM 310 to perform manual installations for the second list. The embodiments are not limited in this context.

In one embodiment, PM 310 may be implemented in accordance with the programming logic described in the following pseudo-code:

agent_install (nodeinfo) {

for each nodeinfo element {

if establish_trust = TRUE;

run_install

}

}

establish_trust {

get agent default trusted user/pass from embedded EIMA database
test authorized connection // with ssh, rsh, telnet and ftp protocols
}

run_install (nodeinfo) {

establish connection to node
copy agent package to node temp directory
run_package
return any errors
}

run_package {

download OS specific agent wrapper
check for required patches
run installation
return any errors
}

In one embodiment, EMAM 328 may include CM 312. CM 312 may configure one or more client agents 1-N installed on nodes 1-M. Each client agent 1-N may be configured to perform a specific set of operations for EIMA 300. CM 312 may send configuration information to a client agent. The configuration information may include various parameters, such as a monitoring policy parameter, a node grouping parameter, a policy assignment parameter, and so forth. The monitoring policy parameter may instruct the node to monitor certain sensors for the node or another node in order to assess processor usage, memory resources, operating status, problem conditions, maintenance conditions, and so forth. The node grouping parameter may inform the node that it comprises part of a defined node grouping, such as a network or subnetwork of nodes. The policy assignment parameter may instruct the node to perform certain operations in response to certain conditions as defined by a rule set. For example, the policy assignment parameter may instruct the node to mirror its information to a redundant node, perform the operations for another node in the event of a failure condition, implement a firewall, and so forth. The type of parameters and their associated operations may vary according to a given implementation, and the embodiments are not limited in this context. The configuration information for each client agent 1-N may be stored in a database, such as database 324.

In one embodiment, CM 312 may be implemented in accordance with the programming logic described in one or more CPLA files as stored on compact discs 1003.0003 CPLA COPY 1 and 1003.0003 CPLA COPY 2, such “TemplateUtilities.java”, for example. The embodiments are not limited in this context.

In one embodiment, EMAM 328 may include RMM 314. RMM 314 may provide users varying levels of administrative access to the configuration information stored in database 324. RMM 314 may be used to give different users varying levels of access to EIMA 300, based upon the role each user has in managing RMM 314. The access permissions may be defined based on actions, nodes, policies, and so forth. For example, RMM 314 may provide a first level of administrative access to identify a subset of operations a user may access from a set of operations. RMM 314 may provide a second level of administrative access to access a set of client agents. RMM 314 may provide a third level of administrative access to access configuration templates corresponding to the configuration information for each client agent 1-N. The number of access levels and corresponding permissions may vary according to a given implementation, and the embodiments are not limited in this context.

In one embodiment, RMM 314 may be implemented in accordance with the programming logic described in one or more CPLA files as stored on compact discs 1003.0003 CPLA COPY 1 and 1003.0003 CPLA COPY 2, such as “PortalFilter.java”, for example. The embodiments are not limited in this context.

In one embodiment, EMAM 328 may include OM 316. OM 316 may provide access to the configuration information to place a client agent 1-N in a maintenance mode. In this manner specified nodes may have scheduled outages for any number of purposes, including removal of a node, replacement of a node, upgrading a node, performing routine maintenance or troubleshooting, and so forth.

In one embodiment, OM 316 may be implemented in accordance with the programming logic described in one or more files as stored on compact discs 1003.0003 CPLA COPY 1 and 1003.0003 CPLA COPY 2, such as “MaintUtilities.java”, for example. The embodiments are not limited in this context.

In one embodiment, EMAM 328 may include UM 318. UM 318 may integrate and execute a set of utility operations. The utility operations may include commonly used infrastructure management system functions.

In one embodiment, UM 318 may be implemented in accordance with the programming logic described in one or more files as stored on compact discs 1003.0003 CPLA COPY 1 and 1003.0003 CPLA COPY 2, such as “GetCommandStatus.java” and “RunCmd.java”, for example. The embodiments are not limited in this context.

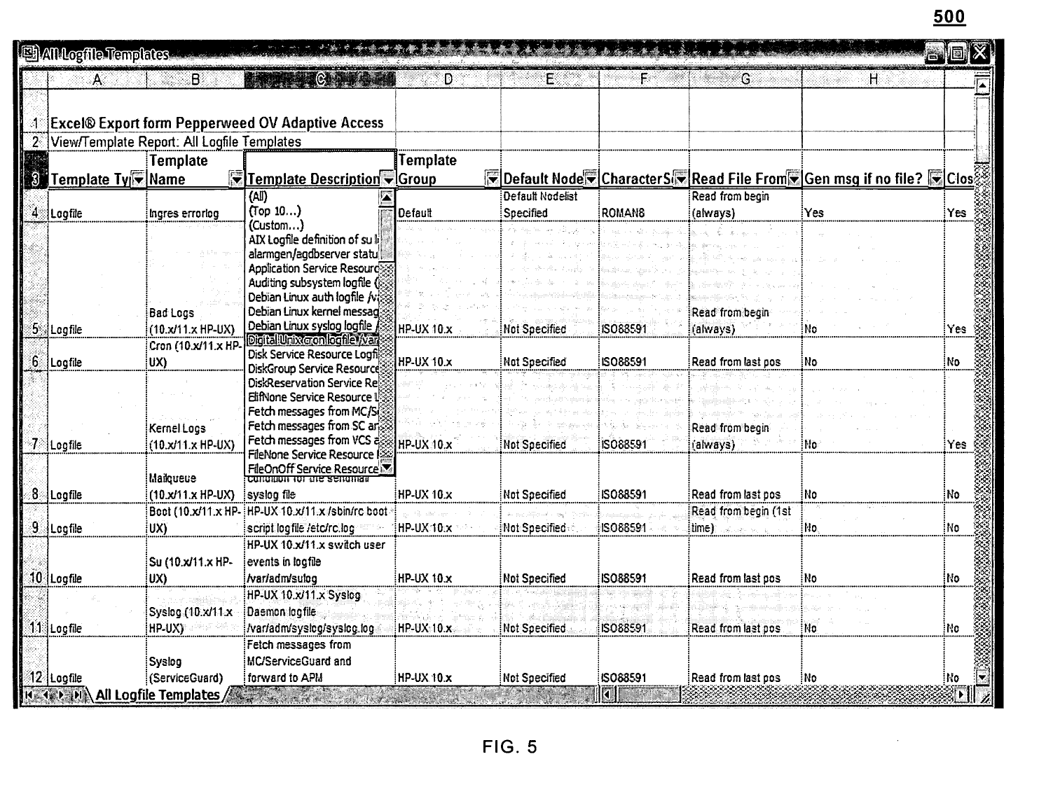

In on embodiment, EMAM 328 may include RPM 320. RPM 320 may be used to perform data extraction and visualization of configurations, status and health of EIMA 300 and client agents I-N. For example, database 324 may store the configuration information using a first data structure. RPM 320 may extract the configuration information from the first data structure, and convert the extracted data to a second data structure. The configuration information may be stored in database 324. RPM 320 may generate a report using the configuration information from the second data structure. In one embodiment, for example, the report may be generated in the form of a Microsoft Excel spreadsheet, as shown in FIG. 5.

In one embodiment, RPM 320 may be implemented in accordance with the programming logic described in one or more file as stored on compact discs 1003.0003 CPLA COPY 1 and 1003.0003 CPLA COPY 2, such as “ChartUtilities.java”, “GridDataServlet.java”, “GenerateExcelServlet.java”, “PieConfigServlet.java”, “PieDataServlet.java” and “ReportUtilities.java”, for example. The embodiments are not limited in this context.

Operations for the above system and subsystem may be further described with reference to the following figures and accompanying examples. Some of the figures may include programming logic. Although such figures presented herein may include a particular programming logic, it can be appreciated that the programming logic merely provides an example of how the general functionality described herein can be implemented. Further, the given programming logic does not necessarily have to be executed in the order presented unless otherwise indicated. In addition, although the given programming logic may be described herein as being implemented in the above-referenced modules, it can be appreciated that the programming logic may be implemented anywhere within the system and still fall within the scope of the embodiments.

FIG. 4 illustrates a block flow diagram for a programming logic 400. FIG. 4 illustrates a programming logic 400 that may be representative of the operations executed by one or more systems described herein, such as systems 100-300. As shown in programming logic 400, a plurality of nodes for a client domain may be discovered at block 402. At least one node may be provisioned with a client agent at block 404. Each client agent may be configured using configuration information at block 406. The configuration information may comprise at least one parameter from a set of parameters to include a monitoring policy parameter, a node grouping parameter, and a policy assignment parameter. The configuration information for each client agent may be stored at block 408. The configuration information may be stored using a first data structure, for example. Multiple levels of administrative access to the configuration information stored in the database may be defined at block 410.

In one embodiment, the multiple levels of administrative access may include a first level of administrative access to identify a subset of operations a user may access from a set of operations. The multiple levels of administrative access may also include a second level of administrative access to access a set of client agents. The multiple levels of administrative access may further include a third level of administrative access to access configuration templates corresponding to the configuration information for each client agent.

In one embodiment, a report may be generated using the configuration information stored in the first data structure. For example, the configuration information may be extracted from the first data structure, stored using a second data structure, with the configuration information stored in the second data structure to be used to generate a report. The report may be generated in the form of a spreadsheet, for example.

In one embodiment, each client agent may be configured using the configuration information as follows. The configuration information may be received in accordance with one of a TCP/IP Specification, HTTP Specification, and SHTTP Specification. Each client agent may be configured using the received configuration information.

FIG. 5 illustrates a report 500 in accordance with one embodiment. FIG. 5 illustrates a report 500 as provided by RPM 320. As shown in FIG. 5, report 500 may comprise a spreadsheet generated using a spreadsheet program, such as Microsoft Excel. As previously discussed, database 324 may store the configuration information using a first data structure. The first data structure may comprise, for example, a template description as defined by EMAPM 326. RPM 320 may extract the configuration information from a selected template description, and convert the extracted data to a second data structure. The converted configuration information may be stored in database 324. RPM 320 may generate a report using the configuration information from the second data structure. Report 500 is an example of a report generated in the form of a Microsoft Excel spreadsheet.

As shown in FIG. 5, report 500 may include various types of configuration information. For example, report 500 may have columns for different types of information for each node, such as Template Type, Template Name, Template Description, Template Group, Default Node, Character Source, Read File From, Generate Message, and so forth. The rows may include configuration information for different nodes within a client domain. The column types and rows of configuration information are by way of example only, and the embodiments are not necessarily limited in this context. In this manner, a user may get a current report of all the technical resources within a client domain or a node group within a client domain, and status and configuration information for the selected nodes. Report 500 may be automatically generated on a periodic basis or in response to an external event. Report 500 may be generated on a periodic basis, and stored in database 324, in anticipation of generating a master report showing status and configuration information for a network over a given time interval or for a particular date and time. Report 500 may also be generated in response to an external event, such as failure of a node, failure of the network, user request, and so forth. The embodiments are not limited in this context.

One or more of the embodiments have been described above as a network appliance, with the network appliance having multiple software modules implemented by a processing system. In one embodiment, EIMA 200 and/or EIMA 300 may be implemented using a modular platform. A modular platform may be a processing system designed to use modular building blocks, such as shelves, compute boards, management modules, Field Replaceable Units (FRU), and other components. In one embodiment, for example, the modular system may comprise an Advanced Telecommunications Computing Architecture (ATCA) system as defined by the PCI Industrial Computer Manufacturers Group (PICMG) 3.x family of specifications, such as the ATCA specification PICMG 3.0, dated Dec. 30, 2002. The modular system may use a number of ATCA compliant components, including a compute board such as the Intel NetStructure™ MPCBL0001 Single Board Computer (SBC), a shelf such as the Intel NetStructure MPCHC0001 14U, and a shelf management module such as the Intel NetStructure MPCMM0001 Chassis Management Module (CMM), all made by Intel Corporation. In one embodiment, for example, EIMA 200 and/or EIMA 300 may be implemented using one or more SBC or “blades” for use with the modular platform. It may be appreciated that the modular platform and described components are by way of example only, and the embodiments are not limited in this context.

All or portions of an embodiment may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

1. An apparatus, comprising:
an enterprise management access module to perform administrative operations for an enterprise management application module, said enterprise management access module to include a web server module to provide remote access to said enterprise management application module, and a role management module to provide different levels of administrative access to said enterprise management application module.

2. The apparatus of claim 1, wherein said enterprise management access module further comprises:
a discovery module to discover a plurality of nodes for a client domain;
a provisioning module to provision at least one node with a client agent;
a configuration module to configure each client agent using configuration information;
a database to store said configuration information for each client agent; and
wherein said role management module to provide different levels of administrative access to said configuration information stored in said database.

3. The apparatus of claim 1, wherein said role management module provides a first level of administrative access to identify a subset of operations a user may access from a set of operations.

4. The apparatus of claim 1, wherein said role management module provides a second level of administrative access to access a set of client agents.

5. The apparatus of claim 1, wherein said role management module provides a third level of administrative access to access configuration templates corresponding to said configuration information for each client agent.

6. The apparatus of claim 1, wherein said configuration information comprises at least one parameter from a set of parameters to include a monitoring policy parameter, a node grouping parameter, and a policy assignment parameter.

7. The apparatus of claim 1, wherein said database stores said configuration information using a first data structure.

8. The apparatus of claim 7, further comprising a reporting module to extract said configuration information from said first data structure, to store said configuration information in a second data structure, and to generate a report using said configuration information from said second data structure.

9. The apparatus of claim 8, wherein said report is generated using a spreadsheet.

10. The apparatus of claim 7, wherein said web server module is arranged to receive said configuration information in accordance with one of a TCP/IP Specification, HTTP Specification, and SHTTP Specification.

11. The apparatus of claim 1, further comprising an outage module to provide access to said configuration information to place said client agent in a maintenance mode.

12. The apparatus of claim 1, further comprising a utility module to integrate and execute a set of utility operations.

13. The apparatus of claim 1, further comprising a database access module to manage access to information stored in said database.

14. A system, comprising:
a plurality of nodes for a client domain;
an enterprise infrastructure management appliance to couple to said nodes, said enterprise infrastructure management appliance to comprise:
an enterprise management application module to perform enterprise management operations for said nodes; and
an enterprise management access module to perform administrative operations for said enterprise management application module, said enterprise management access module to include a web server module to provide remote access to said enterprise management application module, and a role management module to provide different levels of administrative access to said enterprise management application module.

15. The system of claim 14, wherein said enterprise management access module further comprises:
a discovery module to discover a plurality of nodes for a client domain;
a provisioning module to provision at least one node with a client agent;
a configuration module to configure each client agent using configuration information;
a database to store said configuration information for each client agent; and wherein said role management module to provide different levels of administrative access to said configuration information stored in said database.

16. The system of claim 15, wherein said client agent comprises a software agent to monitor one or more operations of said provisioned nodes.

17. The system of claim 15, wherein each client agent sends status information for each provisioned node.

18. The system of claim 14, further comprising:
a network; and
a remote access node to couple to said network, said remote access node to include a web browser module to communicate information between said remote access node and said enterprise infrastructure management appliance over said network.

19. The system of claim 18, wherein said network operates in accordance with one of a TCP/IP Specification, an HTTP Specification, and a SHTTP Specification.

20. The system of claim 14, wherein said enterprise infrastructure management appliance comprises a single board computer for use with a modular platform.

21. A method, comprising:
discovering a plurality of nodes for a client domain;
provisioning at least one node with a client agent;
configuring each client agent using configuration information;
storing said configuration information for each client agent; and
defining multiple levels of administrative access to said configuration information stored in said database.

22. The method of claim 21, wherein said multiple levels of administrative access includes a first level of administrative access to identify a subset of operations a user may access from a set of operations.

23. The method of claim 21, wherein said multiple levels of administrative access includes a second level of administrative access to access a set of client agents.

24. The method of claim 21, wherein said multiple levels of administrative access includes a third level of administrative access to access configuration templates corresponding to said configuration information for each client agent.

25. The method of claim 21, wherein said configuration information comprises at least one parameter from a set of parameters to include a monitoring policy parameter, a node grouping parameter, and a policy assignment parameter.

26. The method of claim 21, wherein said storing comprises storing said configuration information using a first data structure.

27. The method of claim 26, further comprising:
extracting said configuration information from said first data structure;
storing said configuration information in a second data structure; and
generating a report using said configuration information from said second data structure.

28. The method of claim 27, wherein said report is generated using a spreadsheet.

29. The method of claim 21, wherein said configuring comprises:
receiving said configuration information in accordance with one of a TCP/IP Specification, HTTP Specification, and SHTTP Specification; and
configuring each client agent using said received configuration information.

30. The method of claim 21, further comprising providing access to said configuration information to place said client agent in a maintenance mode.

31. An article comprising:
a storage medium;
said storage medium including stored instructions that, when executed by a processor, are operable to discover a plurality of nodes for a client domain, provision at least one node with a client agent, configure each client agent using configuration information, store said configuration information for each client agent, and define multiple levels of administrative access to said configuration information stored in said database.

32. The article of claim 31, wherein the stored instructions, when executed by a processor, perform said defining using stored instructions operable to define a first level of administrative access to identify a subset of operations a user may access from a set of operations.

33. The article of claim 31, wherein the stored instructions, when executed by a processor, perform said defining using stored instructions operable to define a second level of administrative access to access a set of client agents.

34. The article of claim 31, wherein the stored instructions, when executed by a processor, perform said defining using stored instructions operable to define a third level of administrative access to access configuration templates corresponding to said configuration information for each client agent.

35. The article of claim 31, wherein the stored instructions, when executed by a processor, perform said storing using stored instructions operable to store said configuration information using a first data structure.

36. The article of claim 35, wherein the stored instructions, when executed by a processor, are further operable to extract said configuration information from said first data structure, store said configuration information in a second data structure, and generate a report using said configuration information from said second data structure.

37. The article of claim 31, wherein the stored instructions, when executed by a processor, perform said configuring using stored instructions operable to receive said configuration information in accordance with one of a TCP/IP Specification, HTTP Specification, and SHTTP Specification, and configure each client agent using said received configuration information.

38. The article of claim 31, wherein the stored instructions, when executed by a processor, are further operable to provide access to said configuration information to place said client agent in a maintenance mode.
